(19) United States
(12) Patent Application Publication
(10) Pub. No.: US 2025/0117964 A1
(43) Pub. Date: Apr. 10, 2025

(54) Systems and Methods for Mesh Decimation, Mesh Compression, and Intra-Mesh LODs

(71) Applicant: Six Impossible Things Before Breakfast Limited, Dublin (IE)

(72) Inventor: Sherry IGNATCHENKO, Weidling (AT)

(73) Assignee: Six Impossible Things Before Breakfast Limited, Dublin (IE)

(21) Appl. No.: 18/905,852

(22) Filed: Oct. 3, 2024

Related U.S. Application Data
(60) Provisional application No. 63/588,177, filed on Oct. 5, 2023.

(51) Int. Cl. G06T 9/00; G06T 17/20

(52) U.S. Cl. CPC G06T 9/001; G06T 17/205

(57) ABSTRACT

The systems and methods described herein improve the compression of components used to render three-dimensional models in computer-generated graphics, enabling the dynamic rendering of those three-dimensional models. In various implementations, a mesh may be compressed utilizing information obtained during decimation of the mesh. In various implementations, a texture may be compressed using similar techniques to form a continuous level of detail (LOD) of the texture. As also described herein, a three-dimensional model may be dynamically rendered based on a current scene. For example, a mesh for a three-dimensional model may be rendered based on a current desired LOD level for a vertex of the mesh and pre-defined lowest-resolution LOD levels for that vertex.

### RELATED APPLICATIONS

This application claims priority to U.S. Provisional Application No. 63/588,177, entitled “Method for Mesh Decimation, Mesh Compression, and Intra-Mesh LODs,” filed on Oct. 5, 2023, the content of which is hereby incorporated herein by reference in its entirety.

### FIELD OF THE DISCLOSURE

The systems and methods described herein relate to improvements to the compression of meshes used to render computer-generated three-dimensional models.

### BACKGROUND

In computer graphics, meshes consisting of hundreds or thousands of triangles (or other polygons) are frequently used to render three-dimensional models. A technique known as “level of details” (or “LODs”) is frequently used to compress and decompress these computer-generated three-dimensional models. LODs are essentially a sequence of meshes, which may be ordered from highest-quality to lowest-quality, and which are used to show a 3D model with a different number of triangles (usually at different distances).

Mesh decimation, which involves reducing the number of mesh triangles (or other polygons), is a widely used technique in three-dimensional graphics (e.g., in video games) to reduce memory requirements and improve performance. However, as the complexity and detail of online games increases, maintaining an adequate download and loading-to-screen time becomes increasingly difficult. Indeed, as the size of the files needed to render games increases, so too does transmission data size, transmission time, memory usage, and rendering time. Accordingly, improvements are needed in the techniques used to produce the best visually possible meshes for a given number of triangles, incrementally compress such meshes, and render three-dimensional models using such meshes.

### SUMMARY OF THE DISCLOSURE

This disclosure relates to systems and methods for compressing components for use in rendering three-dimensional models in computer-generated graphics and dynamically rendering those three-dimensional models. According to one aspect of the invention, the systems and methods described herein may compress a mesh utilizing information obtained during decimation of the mesh. In various implementations, the information obtained during decimation of the mesh may comprise a record (or history) of the transforms performed on the mesh during decimation. For example, decimating the mesh may include at least one of an edge collapse, half-edge collapse, removal of a face, or addition of a face. Accordingly, the information obtained during decimation of the mesh may comprise a record (or history) of the one or more edge collapse, half-edge collapses, removals of faces, additions of faces, and/or additional transforms performed on the mesh during decimation. In some implementations, decimating the mesh may include comparing the mesh and at least one candidate decimation based on one or more metrics. For example, at least one of the one or more metrics may be based on a silhouette projection for a plane. In some implementations, the one or more metrics may be used to determine, for example, which edge to collapse next. In some implementations, decimating the mesh may include generating a bump map utilizing UV mapping. For example, the bump map may include indications of portions of a geometry of the mesh cut off during decimation.

In some implementations, obtaining a decimated mesh to be compressed may include generating a convex mesh and decimating the convex mesh. For example, generating the convex mesh may comprise identifying at least one non-convex vertex within the mesh, removing any faces adjacent to the identified non-convex vertex, and closing any holes in the mesh resulting from the removal of the faces.

In various implementations, the decimated mesh may be encoded into a compressed stream along with one or more incremental updates using the information obtained during decimation of the mesh. Applying the incremental updates to the decimated mesh may enable the mesh to be reconstructed from the decimated mesh. For example, the one or more incremental updates include at least one of a reversal of an edge collapse or half-edge collapse, a reversal of a face removal, or a reversal of a face addition. In some implementations, the one or more incremental updates may be reordered based on edges in the decimated mesh to which the incremental updates relate.

According to another aspect of the invention, the systems and methods described herein may compress a texture to form a continuous level of detail (LOD) of the texture. In such implementations, an image may be obtained representing a texture. For example, the texture may comprise a square (or non-square) texture. In some implementations, obtaining the image representing a texture to be compressed may comprise performing one or more resizing techniques on an original image representing the texture to obtain a smaller image. In various implementations, a current state of the texture may be obtained, both on the compressor and decompressor side. The current state of the texture may comprise a tree consisting of various nodes. Each node may comprise information sufficient to rasterize the node. For example, each node may comprise one or more generalized images and boundaries between the one or more generalized images. For example, the one or more generalized images may include at least one image block represented as one or more frequency-domain blocks and/or at least one noisy block comprising an image block with additional noise applied to an image described by the image block. The image to be compressed may comprise a raster image, and compressing the image may comprise converting the raster image into an image block representation. In such implementations, compressing the image may include converting the image to another color space, subsampling the image, and/or using two-dimensional frequency-domain transform on a block of pixels of the image to obtain a matrix of frequency coefficients. In various implementations, a command applied to the obtained image may be encoded into a compressed stream. In such implementations, the command may include a serialization of the tree of the current state of the texture. At least one improvement command to be applied to an image rasterized from the current state of the texture may then be encoded into the compressed stream. For example, the at least one improvement command may comprise a scale up improvement, a coefficient improvement, and/or a new split improvement.

According to another aspect of the invention, the systems and methods described herein may dynamically render a three-dimensional model based on a scene. In various implementations, a desired level of detail (LOD) level for a vertex of a mesh may be determined based on a current position of a camera (or viewpoint) relative to the mesh. For example, determining the desired LOD level may comprise calculating a distance between the camera and the vertex. In some implementations, determining the desired LOD level for the vertex may comprise adjusting the desired LOD level based on the presence of one or more other objects between the camera and the mesh to be rendered. For example, the desired LOD level may be adjusted based on a percentage of the mesh to be rendered that is covered by the one or more other objects between the camera and the mesh to be rendered. With a desired LOD level determined, the desired LOD level for the vertex may be compared to a predefined indication of a lowest-resolution LOD level for the vertex. For example, the lowest-resolution LOD level for the vertex may be assigned during mesh design. In some implementations, the lowest-resolution LOD level for the vertex may be indicated by a position of the vertex within an encoded stream. For example, the encoded stream may include at least one marker indicating that vertices in the encoded stream after the marker have a specific lowest-resolution LOD level. If, based on the comparison, it is determined that the lowest-resolution LOD level for the vertex corresponds to a higher resolution than the desired LOD level, the vertex (and the faces and/or triangles associated with the vertex) may be excluded from the rendering of the mesh. For example, excluding the vertex from the rendering of the mesh may comprise using other vertices to form triangles to render the mesh.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRA WINGS

The present invention is illustrated by way of example and not limited in the accompanying figures in which like reference numerals indicate similar elements and in which:

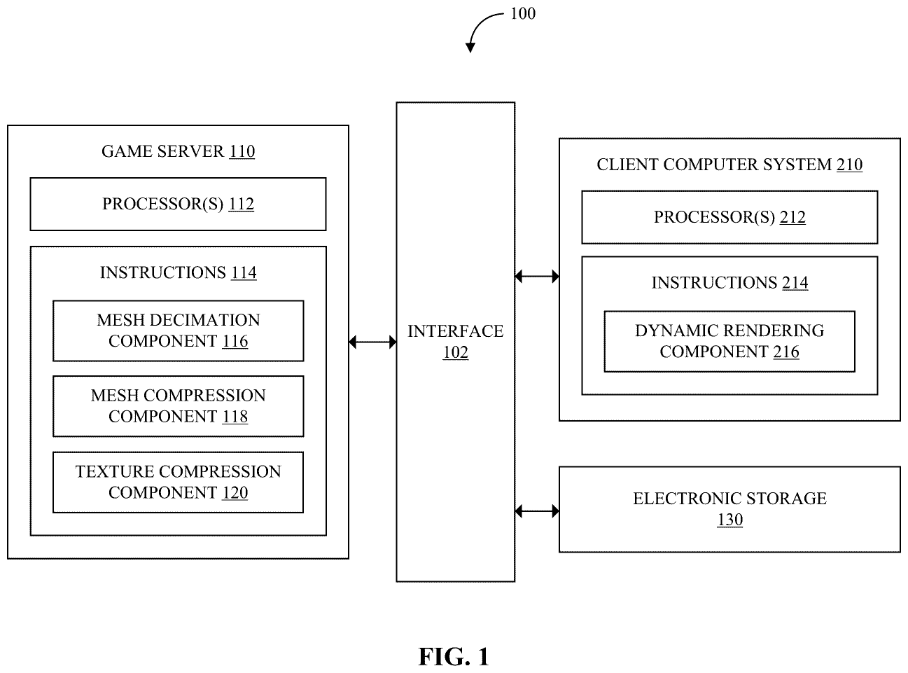

FIG. 1 depicts a block diagram of an example of a system configured to render computer-generated three-dimensional models, according to one or more aspects described herein;

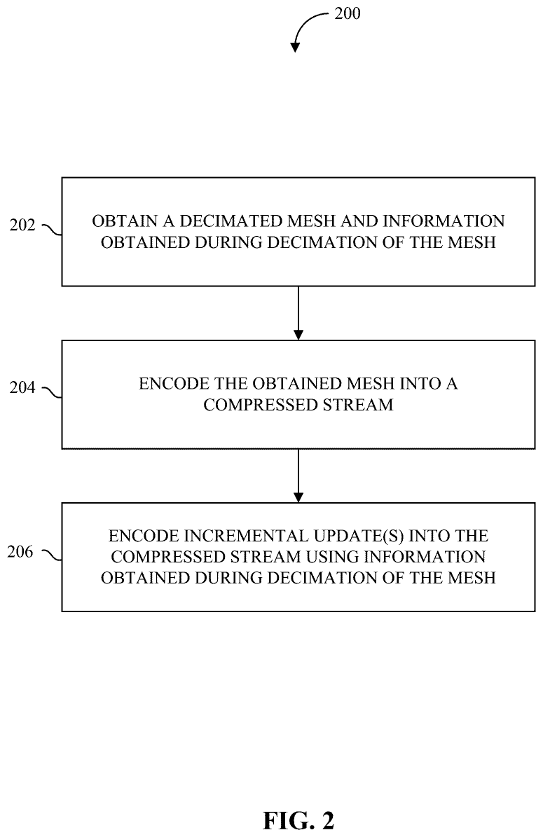

FIG. 2 depicts a diagram of an example of a method for compressing a mesh utilizing information obtained during decimation of the mesh, according to one or more aspects described herein;

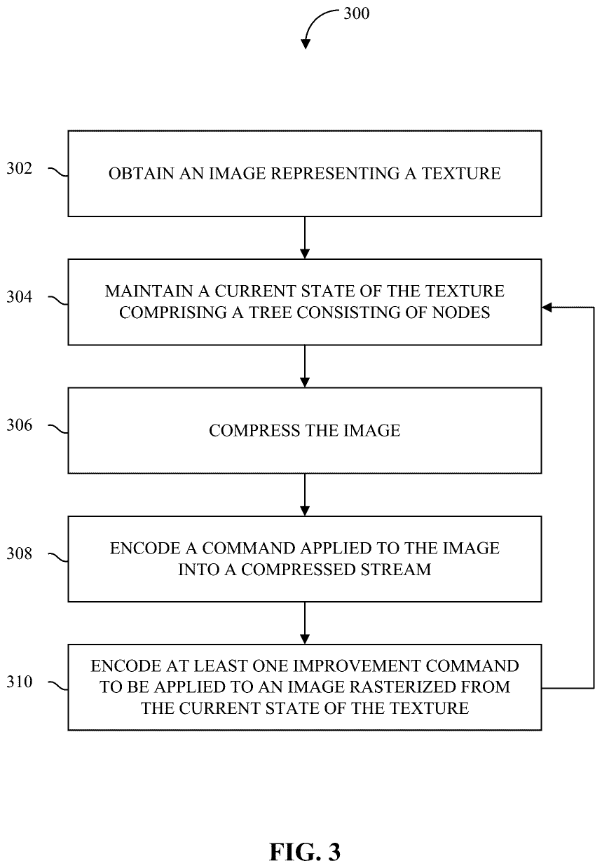

FIG. 3 depicts a diagram of an example of a method for compressing a texture to form a continuous level of detail (LOD) of the texture, according to one or more aspects described herein; and

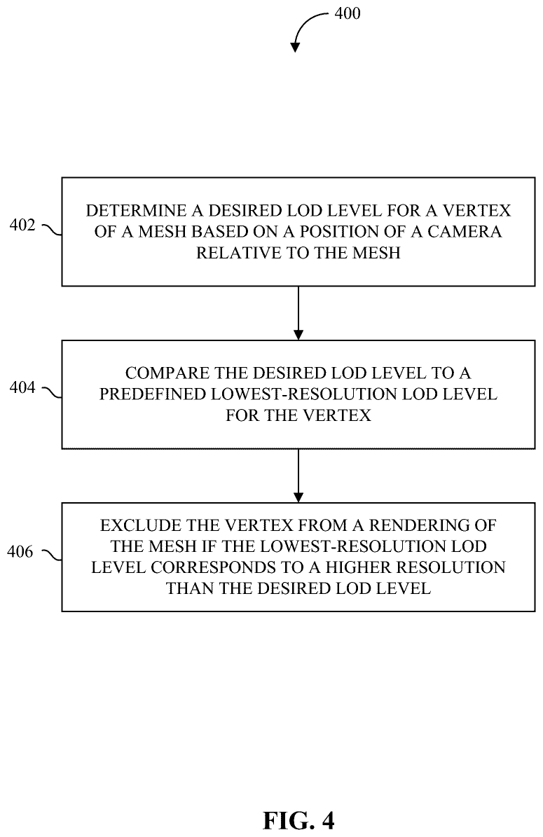

FIG. 4 depicts a diagram of an example of a method for dynamically rendering a three-dimensional model based on a scene, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

FIG. 1 illustrates an example of a system 100 for rendering computer-generated three-dimensional models, according to one or more aspects described herein. In various implementations, system 100 may include one or more of interface 102, a game server 110, electronic storage 130, a client computer system 210, and/or other components. In various implementations, game server 110 may include one or more physical processors 112 (also interchangeably referred to herein as processor(s) 112, processor 112, or processors 112 for convenience), computer readable instructions 114, and/or one or more other components. In various implementations, client computer system 210 may include one or more physical processors 212 (also interchangeably referred to herein as processor(s) 212, processor 212, or processors 212 for convenience), computer readable instructions 214, and/or one or more other components. In various implementations, client computer system (or device) 210 may comprise a game client computing system (or device). In some implementations, client computer system 210 may be configured to receive instructions, game state data, and/or other content from game server 110 related to an online game comprising three-dimensional virtual scenes. Notably, while the techniques disclosed herein may be described with respect to “three-dimensional objects” and “three-dimensional virtual scenes,” the techniques described herein may apply equally to “two-dimensional objects” and “two-dimensional virtual scenes.” As such, all references herein to “three-dimensional objects” and “three-dimensional virtual scenes” may be replaced with “two-dimensional objects” and “two-dimensional virtual scenes,” respectively. In that regard, where appropriate, techniques disclosed herein related to meshes and textures in three-dimensional virtual scenes may be replaced and similarly applied to polygons and images in two-dimensional virtual scenes, respectively. In some implementations, system 100 may include one or more external resources, such as sources of information outside of system 100, external entities participating with system 100, and/or other resources. In various implementations, system 100 may be configured to receive input from or otherwise interact with one or more users via game server 110 and/or client computer system 210.

In various implementations, physical processor(s) 112, 212 may be configured to provide information processing capabilities in system 100. As such, the processor(s) 112, 212 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112, 212 may be configured to execute one or more computer readable instructions 114, 214. Computer readable instructions 114, 214 may include one or more computer program components. In various implementations, computer readable instructions 114 may include one or more of mesh decimation component 116, mesh compression component 118, texture compression component 120, and/or other computer program components, and computer readable instructions 214 may include dynamic rendering component 216, and/or other computer program components. As used herein, for convenience, the various computer readable instructions 114, 214 will be described as performing an operation, when, in fact, the various instructions program the processor(s) 112, 212 (and therefore system 100) to perform the operation.

A person of ordinary skill in the art would recognize that, in some implementations, one or more of computer readable instructions 114 may instead or additionally reside on one or more processors of other devices included within the game design process. In other words, the functionality described herein with respect to one or more of computer readable instructions 114 may instead or additionally be implemented by a game editor or as part of a game building process before a game generated using the techniques described herein is published on a “game server.” In one such example implementation in which the functionality of each of computer readable instructions 114 is instead implemented outside game server 110, game server 110 may comprise a file-serving server (such as a FTP server or HTTP server) or a group of servers operating as a content delivery network (CDN).

In various implementations, mesh decimation component 116 may be configured to decimate a mesh used to render a three-dimensional model. In various implementations, mesh decimation component 116 may be configured to reduce a number of mesh triangles (or polygons) forming a mesh. The triangles (or polygons) forming a mesh may also be referred to interchangeably herein as “faces” of the mesh. In various implementations, mesh decimation component 116 may be configured to start with a mesh referred to herein as an “original mesh.” In some implementations, to generate the “original mesh,” mesh decimation component 116 may be configured to replace all non-triangle polygons in a mesh with triangles. For example, mesh decimation component 116 may be configured to replace all non-triangle polygons in a mesh with triangles using methods described in “Polygon Triangulation,” Wikipedia, The Free Encyclopedia, Jul. 29, 2024 (last visited Oct. 1, 2024), available at https://en.wikipedia.org/wiki/Polygon_triangulation.

In various implementations, mesh decimation component 116 may be configured to apply one or more known methods for decimation to an original mesh that enable metrics to be established for comparing different choices during decimation. Such metrics may be used to indicate how visually close two meshes are, such as an original mesh and one of the decimation candidates. An example of a known method for decimation that allows for different metrics includes the method(s) described in “A General Framework for Mesh Decimation” by Leif Kobbelt et al., which was published in Proceedings of the Graphics Interface in 1998, the content of which is hereby incorporated by reference herein in its entirety. In some implementations, mesh decimation component 116 may be configured to use a method that is based on edge collapsing. For example, the method described in “A General Framework for Mesh Decimation” by Leif Kobbelt et al. is based on a so-called half-edge collapse, which is a specialization of a more generic edge collapse. In implementations using methods based on edge collapsing, edges (or half-edges) are collapsed one by one, and the metrics described herein are used to determine which edge to collapse next.

In various implementations, mesh decimation component 116 may be configured to use one or more different metrics during decimation. The metrics may be used, for instance, as a way to choose which simplification (e.g., such as half-edge collapse) will be applied to the mesh at a current step of the decimation. In some implementations, mesh decimation component 116 may be configured to use metric(s) based on a notion of silhouette projection. A silhouette projection of a mesh for a given plane p may be obtained by projecting all triangles of a mesh to plane p, and then performing a logical “OR” operation on the projected triangles. If a point-on-plane is present in any of the projected triangles, it is considered to be a part of the silhouette projection to plane p. The “OR” operations may be implemented as a bitmap with pixels or in a purely geometrical manner (i.e., with an “OR” of two polygons always being a polygon).

In various implementations, when calculating metrics for decimation describing the difference between two meshes (e.g., an original mesh and a “new mesh”), mesh decimation component 116 may be configured to take one or multiple silhouette projections on planes from a pre-defined set, thereby obtaining multiple silhouette projections for the original mesh (i.e., “silhouette-original p”) and multiple silhouette projections for the new mesh (i.e., “silhouette-new-p”). Then, mesh decimation component 116 may be configured to perform one or more of a set of calculations (such as, for example, the first, second, and/or third metrics described further herein), obtaining a metric for each of the planes p and return some aggregate of these metrics for all p's in the pre-defined set. For example, an aggregate may comprise a sum of metrics for planes p, a sum of squares metrics for planes p, a maximum of metrics for planes p, and/or other combinations of metrics for planes p. An example pre-defined set of planes referenced herein may comprise one or more of: (i) three planes orthogonal to the axes; (ii) three planes orthogonal to the axes plus six planes, each going through (0,0,0) and an edge of a cube with faces going parallel to axes and centered around (0,0,0) plus four planes, each going through (0,0,0) and a vertex of the same cube; and (iii) a set of planes each going through (0,0,0) and having normals, which are defined by their Euler angles, with two of the Euler angles going in pre-defined steps from 0 to 2*pi radians, and 1 Euler angle going in pre-defined steps from 0 to pi radians. Here, “pre-defined steps” may be the same or different for different Euler angles, and can be, for example, pi/4, pi/6, or pi/8.

In some implementations, calculation of a first metric for a plane p may involve calculating silhouette-original-p and silhouette-new-p, ‘XOR’-ing them (i.e., finding points present in one part of a pair that are not present in the other part of the pair) and using as a metric for p a geometrical square of the ‘XOR’-ed silhouettes. In some implementations, a diameter of the largest contiguous polygon within the XOR-ed silhouettes may be used instead of a geometrical square of the ‘XOR’-ed silhouettes.

In some implementations, calculation of a second metric for a plane p may involve calculating an ‘XOR’-ed silhouette (i.e., the first metric above), and then calculating an ‘AND’-ed silhouette (i.e., finding points present in both silhouette-original-p and silhouette-new-p). Then, a metric for a plane p may be an area integral, going over each point of XOR-ed-silhouette and calculating a square (or absolute value) of a distance between the point being integrated and the nearest point of the ‘AND’-ed silhouette. In some implementations, mesh decimation component 116 may be configured to use silhouette-original-p instead of the ‘AND’-ed silhouette. In some implementations, the integral may be calculated either analytically or numerically.

In some implementations, calculation of a third metric for a plane p may involve calculating a line integral along the perimeter of a new silhouette. Then, for each point of the new silhouette, mesh decimation component 116 may be configured to calculate a function (such as a product) of (a) distance from the current point to the nearest point of the old silhouette and (b) angle between direction of the tangent of the new silhouette at the current point and the tangent of the old silhouette at the nearest point of the old silhouette. In some such implementations, new and old silhouettes may be swapped. In some implementations, mesh decimation component 116 may be configured to calculate the integral numerically using small segments along the relevant (or respective) silhouettes. In some implementations, mesh decimation component 116 may be configured to ensure that these small segments never go across the vertex of the polygon, such that tangents are always aligned with the segments themselves.

In some implementations, while performing decimation, mesh decimation component 116 may be configured to generate and keep a bump map, which may be flat at the beginning of decimation. The “bump map” described here may be configured to utilize UV mapping. In some implementations, whenever mesh decimation component 116 performs a decimation step (such as edge collapse or half-edge collapse) that results in a certain part of the geometry of a mesh being cut off, mesh decimation component 116 may be configured to add to the bump map a bump corresponding to this geometry being cut off. Then, after decimation has been completed, mesh decimation component 116 may be configured to either (i) apply the bump map directly to a mesh or (ii) convert it to a normal map and apply it to the mesh as a normal map. In this context, “apply” may include either (i) assigning bump/normal map to the mesh or (ii) combining with any applicable map on the mesh. In this context, “combining” may include (i) adding heights for the bump map or using maximum of the height of bump maps (for example, of the bump map generated as described above, and of any pre-existing bump map) as a new bump map, or (ii) adding deviations from the flat normal map for the normal map or using maximum of deviations from the flat normal map (for example, for bump map generated as described above, and for any pre-existing bump map) as deviations for the new normal map. Using this technique, the generated bump map (and/or normal map) may be used to partially compensate for visual degradation due to decimation.

When decimating a mesh, the techniques used to do so (including, for example, the techniques described herein) may not be able to change the topology of the mesh (e.g., a mesh which is topologically equivalent to a torus will stay a torus). For meshes with a complex topology (such as a mesh of a house with window security bars), the inability to change the topology of the mesh may result in a decimated mesh of significantly reduced quality. The following technique is proposed to address this problem.

In some implementations, mesh decimation component 116 may be configured to determine a distance from which a decimated mesh is going to be viewed. For example, in some implementations, mesh decimation component 116 may be configured to determine that a decimated mesh being generated is an LOD mesh with ˜500 triangles that is intended to be used when the distance from the camera with a 50 mm lens is over 10 m. As used herein, a “camera” may be understood, and referred to interchangeably, as a viewpoint associated with a game client within an online game. In some implementations, mesh decimation component 116 may be configured to determine the maximum size of a hole that may be eliminated for such a distance. For example, for 10 m distances, a maximum hole size may be 20 cm. As used herein, “hole” is a topological term and is explained, for example, in Weisstein, Eric W., “Hole,” MathWorld—A Wolfram Web Resource (last visited Oct. 1, 2024), available at https://mathworld.wolfram.com/Hole.html, the content of which is hereby incorporated herein by reference in its entirety. Objects having a different number and/or configuration of holes have different topologies. For example, a torus is topologically different from a sphere due to the presence of a hole in a torus.

In various implementations, mesh decimation component 116 may then be configured to determine whether there are any holes in the mesh. For example, mesh decimation component 116 may be configured to run decimation methods without any metrics, effectively removing all removable edges without any regards to metrics. Notably, during this “no-metrics” decimation, mesh decimation component 116 may be restricted from collapsing any edge if it leads to collapse of a triangle into an edge. For example, mesh decimation component 116 may not collapse any edge that is shared by more than two triangles. During this “no-metrics” decimation, mesh decimation component 116 may (also) be restricted from collapsing any edge if it leads to collapsing a volume into a flat structure. For example, mesh decimation component 116 may not collapse any edge that, if after the collapse, results in two triangles sharing more than one vertex. During the “no-metrics” decimation, mesh decimation component 116 may be configured to keep track of edges being collapsed (e.g., maintaining a history of edge collapses). Using the history, mesh decimation component 116 may be configured to identify which edges of the original mesh have been collapsed into the edges of the decimated mesh. Note that instead of “no-metrics” decimation, in some implementations, any kind of decimation may be used. When such “no-metrics” decimation cannot be continued, the result will be either a tetrahedron, or there will be one or more collapsed loops (which are made out of the edges of a non-collapsible triangle). For example, if applying no-metrics decimation to a sphere or a cube, the result will ultimately be a tetrahedron (which does not have any “collapsed loops”). However, if applying no-metrics decimation to a torus, the result will ultimately be a mesh with a non-collapsible triangle hole in the middle, and the edge of this triangle hole will constitute a “collapsed loop.” For more complex topologies, there may be more than one such hole and therefore more than one “collapsed loop.” For each of such “collapsed loops,” mesh decimation component 116 may be configured to identify, using the history of edge collapses, which edges of the original mesh have been collapsed into a collapsed loop. In such implementations, the identified edges may form an “original loop,” which amounts to a closed contour consisting of edges of an original mesh surrounding a topological hole (e.g., a hole in a torus) within the original mesh. For each such “original loop,” mesh decimation component 116 may be configured to compare its characteristic size (e.g., its diameter) with the maximum hole size described above. For example, if the characteristic size of an original loop is smaller than the maximum hole size, mesh decimation component 116 may proceed to eliminate the hole. To eliminate the hole, mesh decimation component 116 may be configured to, first, duplicate each of the vertices of the loop. As referred to herein, the vertices of the original loop may be referred to as “VerticesOrig,” and the vertices resulting after the duplication may be referred to as “VerticesA” and “VerticesB.” Second, mesh decimation component 116 may be configured to change faces coming from one side of the original loop (that are using VerticesOrig) to use only VerticesA, and faces coming from the other side of the original loop (that are using VerticesOrig) to use only VerticesB. As a result, a hole may be split into two halves. In some implementations, mesh decimation component 116 may be configured to create new faces, connecting VerticesA with each other, such that the whole contour consisting of VerticesA are covered with triangles. Then, mesh decimation component 116 may be configured to do the same for VerticesB. The resulting new faces (which may be referred to herein as “hole-closing faces”) may ensure that if the original mesh is watertight, the resulting mesh is also watertight. Note that “watertight” and “without holes” are two different concepts. For example, a torus is “watertight” (i.e., it can be filled with water and water will not spill out), but a torus has a topological hole.

Using this process, mesh decimation component 116 may be configured to generate a mesh visually similar to an original mesh with one or more of the holes eliminated, thus resulting in a mesh with a simplified topology. For example, if a hole in the middle of the torus is eliminated using the technique described above, the resulting mesh may become topologically equivalent to a sphere. In such implementations, mesh decimation component 116 may be configured to apply any applicable decimation (including the previously described decimation technique (with metrics)) to the mesh, which will lead to better results because the mesh topology was simplified. Improvements resulting from this technique may be most apparent when applying it to objects with many small holes, such as, for example, window bars, window grids, car grilles, and other objects with many holes. Trying to decimate such objects without simplifying them first may lead to too many triangles being necessary merely to represent the topology, which can result in greatly reduced quality when the objects are decimated to a fewer number of triangles.

In some implementations, mesh decimation component 116 may be configured to keep track of area(s) covered by hole-closing faces. For example, mesh decimation component 116 may be configured to keep track of area(s) covered by hole-closing faces using UV mapping of the mesh by (i) adding transparency to existing texture, (ii) maintaining a separate texture with transparency just for this purpose, and/or (iii) keeping “transparent” polygons in UV space. Then, in some implementations, after any decimation is completed, mesh decimation component 116 may be configured to cut off corresponding areas from the mesh. This approach may result in improved performance as compared to having transparency in the resulting mesh. Alternatively, a mesh with partially transparent textures (as obtained from (i), (ii), or (iii) above) may be used directly for rendering.

In various implementations, mesh compression component 118 may be configured to utilize information obtained during decimation to compress a decimated mesh. In turn, the information obtained during decimation may also be used to decompress a decimated mesh.

In various implementations, mesh compression component 118 may be configured to generate a convex mesh from an original mesh. For example, mesh compression component 118 may be configured to find a non-convex vertex, remove all faces adjacent to the non-convex vertex, and then close hole(s) in a mesh as a result of the removal of the faces. If mesh compression component 118 does not find any non-convex vertices, this means the mesh is already a convex mesh. In some implementations, closing the hole(s) may comprise identifying contour(s) of the hole(s) (which may be found as edges in the mesh which have only one associated triangle), and then filling the contour(s) with faces. In some implementations, after the hole(s) are closed, mesh compression component 118 may find a non-convex vertex, remove all faces adjacent to the non-convex vertex, and then close the hole(s) in a mesh as a result of the removal, as described above. In some implementations, mesh compression component 118 may be configured to decimate a convex mesh before encoding the mesh into a compressed stream (as described further below).

In various implementations, mesh compression component 118 may be configured to encode an initial mesh (which may be an original mesh, an original decimated mesh, or a convex mesh, e.g., as described above-whether decimated or not) into a compressed stream. In various implementations, mesh compression component 118 may be configured to use one or more of existing mesh compression methods to encode the initial mesh. For example, mesh compression component 118 may be configured to use a compression method similar to that of the Draco compression method or some variation of an Edgebreaker algorithm. In an example implementation, mesh compression component 118 may be configured to use a variation of an Edgebreaker algorithm with L and R symbols of Edgebreaker followed by a vertex, where the vertex may be encoded as a difference from a value predicted ‘parallelogram’ predictor (based on three vertices topologically close to the one being added). In such implementations, mesh compression component 118 may be configured to calculate a fourth vertex assuming that four vertices form a parallelogram in three-dimensional space.

After the initial mesh is encoded, mesh compression component 118 may be configured to encode incremental updates into the compressed stream using information obtained during decimation (where decimation was used to convert an original mesh into an initial mesh). In this context, “decimation” includes all transforms, including but not limited to edge and/or half-edge collapses and removal/adding of the faces as a part of forming the convex mesh. Essentially, these incremental updates may be seen as running the history of decimation in reverse, which may allow the original mesh to be reconstructed based on the initial mesh. While applying the incremental updates, removal of vertices from the initial mesh may be avoided, instead only adding new vertices/edges/faces. In some instances, faces may be removed, for example, when mesh compression component 118 encodes reversal of the procedure to make the mesh convex described above. If using edge collapses (specifically that are not half-edge collapses), in some implementations, vertices may also need to be moved.

In various implementations, when encoding reversals of edge/half-edge collapses, mesh compression component 118 may be configured to encode an edge and a difference from vertex coordinates from a predictor. In some implementations, an edge may be encoded as a number in a current list of edges, created by enumeration in the initial mesh, and updated on any incremental update in the same manner on both encoding and decoding sides. When referring to a “predictor,” mesh compression component 118 may be configured to predict a coordinate along an edge at a half of an edge length. Then, in various implementations, mesh compression component 118 may encode a difference between a predicted coordinate along the edge and a coordinate along the edge of an inserted vertex. In some implementations, mesh compression component 118 may be configured to process this prediction (i.e., applying the encoded difference) separately from the other two predictions (discussed further herein) to obtain the coordinate along the edge. Then, with the coordinate along the edge predicted at the midpoint of the edge length, two other coordinates may be predicted by taking a bisect plane of the edge, taking two edge ends (i.e., which lie in the plane), and adding two more points where the bisect plane intersects with mesh edges (e.g., two points closest to the edge ends may be used). The result is four points in the bisect plane, which may be used to mathematically identify a polynomial which describes a curve that goes through the four points (such as a Bezier curve or a spline). Using the coordinate along the edge (obtained by processing the prediction), mesh compression component 118 may be configured to find a corresponding point on this polynomial, go back into three-dimensional coordinate system, and obtain predicted coordinates of a vertex being added. Then, mesh compression component 118 may be configured to encode differences of two inserted vertex coordinates from predicted coordinates. For edge collapses that are not half-edge collapses, mesh compression component 118 may also be configured to encode a distance for which the involved vertex of the edge collapse should be moved.

In some implementations, mesh compression component 118 may be configured to reorder incremental updates. For example, mesh compression component 118 may be configured to issue incremental update(s) in the order based on the edges to which they relate, which may help the encoding of edge numbers. In some implementations, mesh compression component 118 may be configured to combine several vertex insertions to the same edge. In such implementations, if N vertices are inserted into the same edge, mesh compression component 118 may be configured to use

$$i * edge\_length / ( N + 1 )$$

(where i>=1 and i<=N) as the predicted coordinate along the edge for i-th vertex being inserted. For example, this approach may be used in the context of achieving target LOD based on an already-encoded LOD. In such implementations, mesh compression component 118 may be configured to combine all changes leading to the target LOD into one pass over the edges and, for each of the edges, combine all the vertices that need to be inserted.

In some implementations, in order to encode reversal of a face removal (e.g., which may have happened when the mesh was made convex), mesh compression component 118 may be configured to encode (in a list of edges) a number of the first edge, followed by a number of the second edge, using two vertices from the first edge and one vertex from the second edge to create a face (as reversal of face removal may involve creating a new face). In some implementations, such as, for example, when encoding changes in a single pass, mesh compression component 118 may be configured to avoid encoding a number of one of the edges.

In some implementations, in order to encode reversal of face addition (e.g., which may have happened when the mesh was made convex), mesh compression component 118 may be configured to encode a number of an edge, followed by a flag indicating the face needed to be removed (e.g., ‘right’ or ‘left’ one compared to the edge). In such implementations, reversal of face addition may involve deleting an existing face. In some implementations, such as, for example, when encoding changes in a single pass, mesh compression component 118 may be configured to avoid encoding a number of one of the edges.

In some implementations, mesh compression component 118 may be configured to use quantization both for initial mesh encoding and/or for encoding incremental updates.

In various implementations, mesh compression component 118 may be configured to utilize the above description of the encoded mesh as a “continuous LOD” of the mesh geometry. In other words, a mesh may be gradually improving until it reaches its original (pre-decimation) state. According to another aspect of this disclosure, a technique for providing a “continuous LOD” for textures are also described herein.

In various implementations, texture compression component 120 may be configured to compress a texture, forming a “continuous LOD” of the texture. In various implementations, texture compression component 120 may be configured to use the following procedure to compress a two-dimensional texture, which are often square (such as, for example, 4K×4K pixels, 2K×2K pixels, or 1K×1K pixels).

In various implementations, texture compression component 120 may be configured to use a compressed stream comprising commands. In some implementations, texture compression component 120 may be configured to maintain (or store an indication of) a current state. For example, a current state may be kept in sync on both sides (i.e., at the same position within the compressed stream, both the compressor and the decompressor copies of a current state are equivalent or even identical). As referred to herein, the compressor may refer to or be located on game server 110, and the decompressor may refer to or be located on client computer system 210. A current state may comprise a tree consisting of various nodes. Information sufficient to rasterize each node may be included in the current state for each of the nodes of the tree. In various implementations, each of the tree nodes may include (i) one or more “generalized-images” (such as an image block, a noisy block, or a child node) and/or (ii) boundaries between these generalized-images.

As used herein, an “image block” may be represented as frequency-domain blocks (e.g., such as two-dimensional Discrete Cosine Transform (DCT), two-dimensional Discrete Sine Transform (DST), Fourier or Fourier-like representation, or any other representation of frequency domain). In some implementations, such blocks may be square. In some implementations, an alternative representation of an image block may be a bitmap-based (raster) representation.

As used herein, a “noisy block” may be understood as image blocks with additional noise applied to an image. The additional noise may be a pseudo-random noise generated according to specified parameters. In some implementations, such noise may comprise single-color noise (with parameters being, for example, color, magnitude, relative percentage of the color, and/or characteristic grain size). For example, single-color noise may comprise monochrome image-independent zero-mean noise described by an additive noise model (e.g., as such terminology is explained in “Noise Generation” by Robert Fisher et al., Hypermedia Image Processing Reference (2003), available at https://homepages.inf.cd.ac.uk/rbf/HIPR2/noise.htm, the content of which is hereby incorporated herein by reference in its entirety). In particular, gaussian noise (potentially filtered with a low-pass filter), salt-and-pepper, and/or drop-out noise may be used. In some implementations, single-color noise may comprise Perlin noise and/or any combination of the foregoing. In some implementations, monochrome noise may be used as one component in a color space, keeping the other two components of the color space constant. For example, in some implementations, hue and saturation may be constant when using HSL color space, using monochrome noise for lightness. As another example, in some implementations, huc and lightness may be constant, using monochrome noise for saturation. Similarly, any combination of the above may be used. Noise generation methods used in existing image compression algorithms, such as JPEG XL's and/or AVI/AVIF's “noise synthesis” or any combination thereof may also be used. In some implementations, monochrome noise (e.g., generated using any of the methods described above) may be used as an alpha channel over a bitmap that has some solid color or some noise (e.g., generated using any one of the methods described above). Then, when rasterizing the image-noise block as a whole, the bitmap could be obtained and applied on top of the image block (taking into account transparency). Here, pseudo-randomicity (as opposed to real randomicity) may be used to ensure that rasterization on both the compressor and the decompressor is exactly the same.

As used herein, a boundary (as in “boundaries between these generalized-images” as discussed with respect to nodes above) may be represented as potentially-curved lines. Boundaries may, in turn, be represented as a sequence of segments, where segments may be any straight or curved two-dimensional segments, including but not limited to straight line segments, segments of conic section/quadratic curves, splines, and/or Bezier curves. Note that a polygon is a special case of a boundary (with all the segments being straight segments).

Referring back to the current state discussed above, each of the tree nodes may have one “main” generalized-image and a set of pairs (wherein each of the pairs describes a boundary and generalized-image(s)). The foregoing may be used to rasterize the node. For example, in some implementations, texture compression component 120 may be configured to apply all the pairs on top of the “main” image, with each pair defining a generalized-image and boundary, where a part of a generalized-image may be first cut off according to the boundary, and then applied on top of the main image. In some implementations, “cutting-off” and/or “applying” may involve anti-aliasing (which may improve image quality near the boundaries).

With the foregoing, the rasterization of a whole tree may be understood as rasterization of its root node. In some implementations (particularly, when rendering for the purposes of calculating per-pixel differences as described further herein), noisy blocks may be rasterized to avoid using any noise (e.g., by rasterizing noisy blocks only as their image block). When the same image is rasterized for visualization, the noisy blocks may be rendered using their noise part as well.

In various implementations, image blocks may be created from a raster image. For example, texture compression component 120 may be configured to convert an input raster image into an image block representation using one or more quality parameters. In some implementations, texture compression component 120 may be configured to use any existing image compression method, including PNG, JPEG, JPEG XL, AVIF, and/or WebP, to convert an image raster image into an image block. In other implementations, texture compression component 120 may be configured to convert an input image to another color space (e.g., YCbCr similar to JPEG, XYB similar to JPEG XL, or any of now known or later defined color spaces). In some implementations, texture compression component 120 may be configured to subsample the input image, similar to JPEG and/or JPEG XL. In alternative implementations, texture compression component 120 may be configured to use two-dimensional DCT (or some other frequency-domain representation) on the block of pixels of smaller texture to obtain matrix of frequency coefficients similar to JPEG and/or JPEG XL. In particular implementations, texture compression component 120 may be configured to use predictors (e.g., a chroma-from-luma predictor) and quantize coefficients similar to the techniques used in JPEG/JPEG XL. However, in some implementations, lossless compression techniques such as differential pulse-code modulation (DPCM), zig-zag scanning, run-length encoding (RLE), and/or entropy coding may be used. In other implementations, such lossless compression techniques may be used later when serializing image blocks. In some implementations, quantization may (a) effectively define quality and (b) statistically correspond to dropping of higher frequencies in frequency-domain space. In some implementations, an inverse DCT (or inverse transform-from-frequency-domain) may be used to rasterize an image block.

In various implementations, texture compression component 120 may be configured to find a potential split when given a node of a current state. In some implementations, texture compression component 120 may be configured to obtain a node of a tree of a current state as an input parameter. In some implementations, texture compression component 120 may be configured to rasterize said node (as described herein). Then, texture compression component 120 may be configured to calculate per-pixel differences between the images (e.g., in RGB, SRGB, YCbCr, or XYB color space). For example, texture compression component 120 may be configured to calculate per-pixel differences between the resulting rasterized image (which may represent current state of compression/decompression) and the part of original (uncompressed) image which corresponds to the area covered by the node. These differences, in a sense, represent how the pixels of a current state need to be adjusted so they become identical to the respective pixels of the original image.

In some implementations, texture compression component 120 may be configured to calculate per-pixel differences based on peak signal-to-noise ratio (PSNR), square-error, or calculating the structural similarity index measure (SSIM) (or SSIM variations such as multi-scale structural similarity index measure (MS-SSIM), data structural similarity index measure (DSSIM), or universal quality index (UQI)) window around each pixel. Then, texture compression component 120 may be configured to use a calculated value for the window as a per-pixel difference. In some implementations, either alternatively or additionally, texture compression component 120 may be configured to use a “local similarity map” as explained, for example, in “FSIM: A Feature Similarity Index for Image Quality Assessment” by Zhang et al., available at https://www4.comp.polyu.edu.hk/˜cslzhang/IQA/TIP_IQA_FSIM.pdf, the content of which is hereby incorporated herein by reference in its entirety, and use some averaged window over this local similarity map. In some implementations, texture compression component 120 may be configured to represent per-pixel differences as a greyscale image. In some implementations, texture compression component 120 may be configured to apply smoothening, blurring, and/or normalization to the greyscale image. In some implementations, texture compression component 120 may be configured to apply a threshold to make all pixels below the threshold black, and make pixels above the threshold white to achieve a monochrome (2-color black-and-white) image. In some implementations, texture compression component 120 may be configured to apply any boundary-tracing methods (e.g., as described in “Boundary tracing,” Wikipedia, The Free Encyclopedia, May 25, 2024 (last visited Oct. 1, 2024), available at https://en.wikipedia.org/wiki/Boundary_tracing, the content of which is hereby incorporated herein by reference in its entirety) to find a list of boundary polygons (sometimes referred to herein simply as “boundaries”).

In various implementations, texture compression component 120 may be configured, for each of these boundaries, to separate the area which corresponds to the area inside the polygon, from the area outside of the polygon (in other words, to separate the “parts” of the image). Note that, in some implementations, texture compression component 120 may be configured to use anti-aliasing along the boundary when combining the areas into a resulting image. As such, the pixels along the boundary may be considered relevant to both areas. Each of the separated areas may be treated as a separate image, and, for each of which, a separate image block may be created (e.g., using the image block creation technique(s) described herein). In some implementations, texture compression component 120 may be configured to use lower quality parameters (for example, using higher compression, which may involve such things as using fewer bits per pixel, and/or allowing for higher deviations from the original, and/or lower quality parameter of the underlying lossless algorithm such as JPEG or AVIF) when creating some or all of such image blocks. In some implementations, if the size of some part fits into a smaller image block (which in turn may be defined by a smaller DCT block), texture compression component 120 may be configured to create only a smaller image block for this part.

In some implementations, when creating an image block for an image part, texture compression component 120 may be configured to use pixels not relevant to a current part as wildcards. For example, when creating an image block, texture compression component 120 may be configured to use any parameters (such as DCT coefficients), so that parameters correctly approximate non-wildcard pixels (and thus have “ANY” values in wildcard pixels). Alternatively and/or additionally, texture compression component 120 may be configured to use one or more techniques that treat any of the pixels not relevant to a current part as “unused pixels” as described, for example, in U.S. patent application Ser. No. 18/425,525, entitled “SYSTEMS AND METHODS FOR IMPROVING COMPRESSION OF 3D TEXTURES USING UNMAPPED PIXELS,” filed Jan. 29, 2024, the content of which is hereby incorporated by reference herein in its entirety.

In some implementations, texture compression component 120 may be configured to use one or more parts of the image that is not described well by image-block encoding methods. For example, image similarity may be too low for a given encoded size or too large for a given image similarity. The foregoing may indicate that this block is best represented as a “noisy” block. In some implementations, texture compression component 120 may be configured to take an approximation of a block (e.g., by creating an image block out of the raster image of the part) and then rasterize it back to get an “approximated raster,” then find color distribution of the pixels which are significantly different between the original raster image of the part and the approximated raster, and depending on the color distribution, decide which of “noisy block” representations described above (and with which parameters) is more suitable.

In some implementations, texture compression component 120 may be configured to check if an improvement of any of pre-defined desirable characteristics are obtainable if the texture is split alongside the boundary found, for example, as specified above. Such desirable characteristics may include, for example, a better quality/size ratio, a smaller size while staying within a predefined quality (for example, within predefined PSNR or SSIM metrics for the compressed image), better quality while staying within a predefined size, and/or other desirable characteristics. If there is an improvement in any desirable characteristics if the image were split alongside the boundary, it may indicate that a “potential split” exists, which may be represented as a potential replacement of the tree node which was passed as an input parameter, with a tree consisting of (i) one part of the image (as an image block), (ii) another part of the image (also as an image block), and (iii) a boundary between them. For example, if there is a texture split into two parts by a line, and one part is evenly blue and another part is evenly red, frequency-domain representation may not be efficient due to artifacts along a border and/or its significant size. However, if there are areas split along a line, each of the evenly-colored split parts may be encoded in frequency/DCT domain by one single color (e.g., DC coefficient), which may provide both better picture quality and a smaller size than DCT-based encoding of the whole block.

In some implementations, texture compression component 120 may be configured to smoothen a polygon using any above-disclosed mesh decimation technique but applied to the two-dimensional polygon instead of the mesh (e.g., removing vertices or using metrics for polygon difference), and/or using techniques described in “Ramer-Douglas-Peucker algorithm,” Wikipedia, The Free Encyclopedia, Aug. 16, 2024 (last visited Oct. 1, 2024), available at https://en.wikipedia.org/wiki/Ramer-Douglas-Peucker_algorithm, the content of which is hereby incorporated herein by reference in its entirety. In some implementations, texture compression component 120 may be configured to approximate several segments with a curve segment such as a Bezier curve or a spline. For example, at each iteration of the Ramer-Douglas-Peucker (RDP) algorithm, texture compression component 120 may be configured to approximate with a curve a segment currently considered by RDP.

In some implementations, texture compression component 120 may be configured to approximate a polygon with a line representing a symbol from a font which may be defined by vector representation. For example, a True Type font is often described in terms of spline segments, which texture compression component 120 may be configured to interpret as a boundary. Fonts used for such purpose may be present on both the compressor and the decompressor side. If there is a good enough match, texture compression component 120 may be configured to represent a boundary as a reference to the symbol, potentially along with position, rotation, scale, and/or other parameters. In some implementations, the fonts included in the set of fonts on both sides (i.e., on both the compressor and the decompressor side) may include fonts which contain one or more Unicode blocks, including, for example, “Geometric shapes” (U+25A0-U+25FF), “Dingbats” (U+2400-U+27BF), “Miscellaneous Technical” (U+2300-U+23FF), “Miscellaneous Symbols” (U+2600-U+26FF), “Ornamental Dingbats” (U+1F650-U+1F67F), “Supplemental Symbols and Pictographs” (U+1F900-U+1F9FF), and/or “Miscellaneous Symbols and Pictographs” (U+1F300-U+1F5FF).

With the foregoing, texture compression component 120 may be configured to compress a texture (or image) to form a “continuous LOD” of the texture. In various implementations, texture compression component 120 may be configured to obtain an original image as an input. In some implementations, an input image may be a square image or square texture only. In other implementations, input image may be non-square images. In some implementations, texture compression component 120 may be configured to generate a smaller image from an original image (e.g., 16×16, 32×32, or 64×64) using any of image resizing method(s), including but not limited to bilinear, bicubical, lanczos, and frequency-domain transforms, such as Fourier-transform-based or DCT-based. In various implementations, the resulting smaller image may be compressed using any suitable image block compression procedure (including those described herein). In some such implementations, the smaller image may be compressed using a pre-defined value for a quality parameter.

In various implementations, texture compression component 120 may be configured to apply a procedure to find a potential split on any parent node (including a root node) of a node within the current state. Depending on whether the returned result provides more desirable characteristics, texture compression component 120 may be configured to replace the parent node of the current state with this result. In various implementations, texture compression component 120 may then be configured to encode (or emit) a command applied to the initial image into a compressed stream, with this command containing a sequence (or serialization) of a tree of a current state. While encoding (or compressing) the tree, texture compression component 120 may be configured to use any techniques described, for example, in U.S. patent application Ser. No. 18/438,702, entitled “SYSTEMS AND METHODS FOR IMPROVING COMPRESSION OF STRUCTURED DATA IN THREE-DIMENSIONAL APPLICATIONS,” filed Feb. 12, 2024, the content of which is hereby incorporated by reference herein in its entirety, and/or techniques such as zig-zag scanning, RLE, DPCM, and/or entropy coding.

After decoding the portion of the compressed stream described thus far, the decompressor side may have the same current state, which is a rough approximation of the original image. In some implementations, the decompressor may be configured to rasterize the current state and use this rasterization for visualization while a remaining portion of the compressed stream is being transferred/decoded, effectively providing a basis for gradual improvement.

In various implementations, texture compression component 120 may be configured to encode one or more improvement commands into the compressed stream to improve the image rasterized from the current state. For example, the one or more improvement commands may include one or more of a “scale up” improvement command, a “coefficient improvement” improvement command, a “new split” improvement command, and/or one or more other commands.

In some implementations, texture compression component 120 may be configured to encode (or emit) a “scale up” improvement command to be applied to an image. For example, texture compression component 120 may be configured to encode a command that, when applied to an image, results in scaling up the image by 2× or some other power of 2. In some implementations, texture compression component 120 may be configured to encode a “scale up” improvement command for a decompressor to rasterize a current state, scale a rasterized bitmap image (e.g., using conventional image scaling methods such as bilinear, bicubical, lanczos, frequency-domain transforms, and/or other scaling methods), and then create an image block out of the scaled rasterized bitmap image, replacing the whole current state with the only node with this image block. In some implementations, if frequency-domain representation (such as DCT) is used to represent an image block of a current state, texture compression component 120 may be configured to encode a command to apply frequency-domain representation to a larger number of pixels, thereby rasterizing and scaling the image together instead of rasterizing and then scaling the image).

In various implementations, each of the tree nodes may be kept, scaling them up individually. For example, an image block may be scaled up as an image. In some implementations, if frequency-domain (e.g., such as DCT) is used to represent an image block, it can be scaled up either via rasterization and back, or by staying in frequency-domain and filling coefficients for frequencies newly appearing in the matrix with zeros. In some implementations, when scaling up, instead of increasing a size of a single block (e.g., a DCT block), the “scale up” improvement command may instruct (or cause) the decompressor to “break” (not to be confused with “split”) a single block into four (2×2) blocks of the same size. In such implementations, the command may also instruct (or cause) the decompressor to break boundaries so that each of the boundaries corresponds to a single block after the break. When performing a break, representations in frequency domain/DCT may be kept. For example, the command may also instruct (or cause) the decompressor to move to the space-domain (e.g., using inverse DCT), and then use DCT over smaller blocks. To scale up boundaries and noise within noisy blocks, in some implementations, the command may instruct (or cause) the decompressor to simply scale the relevant parameters. For example, for a line segment (which may be a part of boundary), the command may instruct (or cause) the decompressor to multiply each of the coordinates for its ends by 2.

In some implementations, texture compression component 120 may be configured to encode (or emit) a “coefficient-improvement” improvement command to an image. For example, texture compression component 120 may be configured to encode (or emit) a “coefficient-improvement” improvement command to an image that applies to all or some of the nodes in a current state. In some implementations, for frequency-domain/DCT blocks, a “coefficient-improvement” improvement command may include corrections (such as additional bits) for their coefficients (effectively moving to a different level of quantization). In other implementations, for example, for boundaries, a “coefficient-improvement” improvement command may add additional points/segments to a curve and/or include corrections (such as additional bits) for coefficients/coordinates describing a curve (such as point/control point coordinates and spline coefficients).

In some implementations, texture compression component 120 may be configured to encode (or emit) a “new split” improvement command to an image. For example, on a compressor side, a procedure to find a potential split on a root of a current state may be performed, as described herein. Based on the desirable characteristics obtained by such a split, texture compression component 120 may be configured to decide to issue (or emit to a compressed stream) a “new split” improvement command. Such a command may include (i) a new boundary and/or (b) an image-block describing an area within a boundary. This image-block may differ from a conventional image block in that its pixels may specify a difference from an existing underlying image. In some implementations, such a “differential image block” may be implemented as an image with transparency (e.g., implemented using an alpha channel).

In some implementations, when there are multiple blocks (e.g., due to a “scale up” command which resulted in DCT block being “broken” into four blocks, as described herein), texture compression component 120 may be configured to detect if some of the potential splits, found by applying a procedure to find a potential split over each of such multiple blocks, can be represented as one single boundary going across more than one of the multiple blocks. In such instances, texture compression component 120 may be configured to merge such “new splits” together and encode it as one single boundary and one single image block.

In some implementations, when creating a new split, texture compression component 120 may be configured to look if, after the split, one or more sub-trees representing potential splits, are similar to an already-existing sub-tree within a current state. In such cases, a “new split” improvement command may include a reference to this already-existing sub-tree and may use some or all of its data. For example, in some implementations, “similar to” may correspond to having similar coefficients in the frequency-domain. In such implementations, using some or all of the data of the already-existing sub-tree may comprise re-using coefficients (optionally encoding differences from coefficients). As another example, in some implementations, “similar to” may correspond to a boundary being similar. In such implementations, using some or all of the data of the already-existing sub-tree may comprise, for example, re-using a boundary and, if necessary, adjusting it by adding new vertices and/or adjusting segment coefficients. For example, it may be implemented in a manner similar to improvements disclosed by “coefficient-improvement” improvement command described herein.

In some implementations, when choosing which improvement commands to apply (or cause a decompressor to apply) to the image, texture compression component 120 may be configured to use the balance of improvement of desired characteristics compared to the command size. For example, texture compression component 120 may be configured to use an image-similarity metric (such as SSIM, PSNR, or any other similarity metrics), and then use some function taking into account the relative improvement and size of each improvement command to choose which improvement to issue.

In some implementations, when issuing a “coefficient-improvement” improvement command against a sub-tree that is used in more than one place (e.g., via a reference to a sub-tree), texture compression component 120 may further be configured to decide (and indicate within the command) that it is necessary to “break” the reference. In such implementations, texture compression component 120 may be configured to (i) replace a reference with a copy of a sub-tree and (ii) apply “improvement” only to one of the copies of the sub-tree. Otherwise (i.e., if the reference were not broken), the “improvement” may be applied to a sub-tree which is still referenced, so that improvement may apply to all uses (directly or by reference) of the sub-tree in the image.

According to another aspect of the disclosure, and closely related to LODs and gradual quality improvement, techniques are disclosed herein for performing dynamic reduction of the number of triangles in a mesh that need to be shown by a GPU at any given moment without substantial reduction in visual quality. Conventionally, such tasks may be solved using “clusters” of triangles, as described, for example, in “Nanite Virtualized Geometry,” Unreal Engine 5.5 Documentation (last visited Oct. 1, 2024), available at https://dev.epicgames.com/documentation/en-us/unreal-engine/nanite-virtualized-geometry-in-unreal-engine. In contrast, a technique is disclosed herein that uses per-vertex designation of “LOD-ness.” “LOD-ness” may refer to a number of lowest-resolution LOD where a vertex (and/or associated edges and faces) should appear. This LOD-ness may be assigned as a part of mesh design or, for meshes compressed (or encoded) as described herein, may be identified by the position of the vertex within the encoded stream. For example, mesh compression component 118 may be configured to include markers in the encoded stream, with the markers essentially indicating that all vertices encountered in a stream after a marker, and before next such marker, will have an LOD-ness of N (i.e., marker is effectively saying “LOD #N starts here”). In some implementations, LOD-ness may be assigned not to vertices, but rather to faces (or even to edges). In some implementations, LOD-ness may be used to generate clusters.

In various implementations, dynamic rendering component 216 may be configured to manage the dynamic reduction of the number of triangles when rendering a mesh based on a scene. In various implementations, all the vertices of a mesh (or at least a large portion of them) may be loaded to GPU memory (e.g., VRAM). In various implementations, when beginning to render a mesh (e.g., in the context of a game frame), dynamic rendering component 216 may be configured to designate, given a current position of a camera, a desired LOD level to all (or some) vertices of the mesh. For example, dynamic rendering component 216 may be configured to find a desired-LOD-level based on a distance of a respective vertex from a camera. In some implementations, desired-LOD-level may be calculated based on a distance of the whole object/mesh from the camera.

In some implementations, dynamic rendering component 216 may be configured to consider the presence of other objects/meshes between a camera and a mesh to be rendered (instead of or in addition to a distance of respective vertices from a camera). For example, if another object/mesh (or its bounding box) covers (or obscures) portions of a mesh from a current position of a camera, dynamic rendering component 216 may be configured to adjust a desired LOD level corresponding to a lower-resolution. In various implementations, how much lower-resolution to use for a desired LOD level may depend on a percentage covered. This technique may be referred to herein as “soft occlusion.” In some implementations, if bounding boxes are used, dynamic rendering component 216 may be configured to consider, for a specific obscuring mesh, a typical (or average) percentage of the bounding box projection that is covered by the obscuring mesh rendering. For example, if an obscuring mesh is a suitcase, a percentage may be close to 100%, but if it is a character, a percentage may be around 10-20%.

In some implementations, dynamic rendering component 216 may be configured to apply logic similar to this “soft occlusion” (i.e., make a desired LOD level corresponding to lower-resolution) for those vertices (or parts of the object) which, given the current camera position and/or angle with regards to a given mesh, are significantly covered by the mesh itself. The application of this technique to such meshes may be referred to herein as “self-occlusion.”

In some implementations, the one or more techniques described herein may be utilized to compress skinned meshes. A “skinned mesh” may comprise a mesh that has a skeleton and bones that can be used to animate the vertices of the geometry (as described, for example, in “Skinned Mesh Animation Using Matrices” by Bruce J. Veazie, which can be found at https://www.gamedev.net/tutorials/programming/graphics/skinned-mesh-animation-using-matrices-r3577/, the content of which is hereby incorporated by reference herein in its entirety). Each of the vertices of a skinned mesh may correspond to up to four or more “(bone_index, bone_weight)” pairs. These “(bone_index, bone_weight)” pairs define up to four skinning bone weights that may affect a vertex in a mesh. The “bone_index” may comprise the index for a given bone, or otherwise identify a bone, and the “bone_weight” may indicate a skinning weight for that bone. In various implementations, an initial skinned mesh may be compressed using one or more techniques described herein, with the addition of a per-vertex array of (bone_index, bone_weight) pairs. Each vertex may be said to have a “bone_weight” for every “bone_index,” but only those that are non-zero (and/or the highest ones) may be encoded. In some implementations, the initial skinned mesh may comprise an LOD mesh.

In some implementations, if an object uses skinned meshes (and/or moving/animated sub-meshes), dynamic rendering component 216 may be configured to calculate a desired LOD level considering vertex positions over possible movements of vertices caused by “skinning” of a mesh. For example, dynamic rendering component 216 may be configured to take all possible skinned-mesh positions of a vertex over all vertex movements caused by the skinning, and take the “closest” of a desired LOD levels of positions, as a desired LOD level for the vertex. In some implementations, “all possible skinned-mesh positions” may be an approximation (for example, obtained by sampling within possible joint-transformation space of the skinned mesh). In some implementations, dynamic rendering component 216 may be configured to pre-calculate a desired LOD level in advance. In some implementations, dynamic rendering component 216 may be configured to use separate pre-calculated values for separate cubes of possible joint-transformations.

With an identified desired LOD level for the vertices of a mesh, dynamic rendering component 216 may be configured to compare the “LOD-ness” of a vertex with a desired LOD level calculated for that vertex. If the “LOD-ness” of a vertex corresponds to a higher resolution than the desired LOD level, dynamic rendering component 216 may be configured to exclude that particular vertex from a current rendering and use other vertices (i.e., vertices with LOD-ness corresponding to lower resolution) to form triangles/faces used to render a mesh. For example, dynamic rendering component 216 may be configured to exclude a vertex from a rendering and use other vertices to form triangles used to render the mesh by removing all faces coming from that to-be-excluded vertex and closing any holes that appear as a result of the removal of said faces.

In various implementations, dynamic rendering component 216 may be configured to load a list of triangles (described, e.g., using vertex indexes) to the GPU memory and render the mesh. As vertices do not change during this process, dynamic rendering component 216 may be configured to avoid reloading vertices to GPU memory, instead reloading only relatively small list of triangles.

In some implementations, dynamic rendering component 216 may be configured to run this vertex-excluding process incrementally, allowing calculations to spread over several frames. In some implementations, dynamic rendering component 216 may be configured to apply a new list of triangles either in each frame, after several frames, when calculations are finished, and/or as calculations are gradually performed.

In some implementations, dynamic rendering component 216 may be configured to avoid reloading a list of triangles too often. Instead, dynamic rendering component 216 may be configured to reload lists of triangles based on restrictions on a minimum time between reloads and/or on a minimum change of a mesh required for reload. For example, dynamic rendering component 216 may be configured to reload lists of triangles based on restrictions on a minimum change of a mesh required for reload, wherein a minimum change of a mesh may be defined, for example, in terms of the number of vertices that changed their respective desired LOD level.

When the camera position with respect to a mesh changes and/or when objects are moving, dynamic rendering component 216 may be configured to add more faces to a list of triangles, so that faces/triangles corresponding to vertices with an updated desired LOD level (which now should not be excluded according to the criteria disclosed above) are included into a list of triangles to be rendered. Once again, as vertices do not change during this process, dynamic rendering component 216 may be configured to avoid reloading vertices to GPU memory, instead reloading only a relatively small list of triangles.

In some implementations, the foregoing techniques for dynamically reducing the number of triangles when rendering a mesh based on a scene (which may be referred to generally as “Intra-Mesh LOD”) may be extended for use with respect to the handling of textures. For example, dynamic rendering component 216 may be configured to perform such techniques with respect to the handling of textures (described further herein) to save on GPU memory. To implement such techniques, there may be two (or more) different textures of a given mesh—at least one higher-resolution texture and at least one lower-resolution texture. For example, a lower-resolution texture may be used for mipmapping. As another example, a lower-resolution texture may correspond to a lower LOD level in a stream.

In various implementations, dynamic rendering component 216 may be configured to split a mesh into two (or more) parts (e.g., one part comprising faces having vertices with a higher desired LOD level and another part comprising faces having vertices with a lower desired LOD level). In some implementations, dynamic rendering component 216 may be configured to move some faces from one part to another part because of continuity of a mesh and/or a corresponding part of texture(s).

In some implementations, dynamic rendering component 216 may be configured to load only part of the higher-resolution texture into GPU memory, with such a part corresponding to faces with a higher desired LOD level. In such implementations, dynamic rendering component 216 may be configured to load the whole lower-resolution texture (or only its part corresponding to faces with lower desired LOD level) into GPU memory.

In some implementations, when rendering the aforementioned parts of a mesh, the data needed (and used) by dynamic rendering component 216 to render each part may be the same except for a list of triangles to be used to render the individual part and any texture(s) to be applied.

In some implementations, dynamic rendering component 216 may be configured to adjust UV mapping to introduce offset so that a part of a higher-resolution texture has proper UV mapping. For example, UV mapping may be adjusted by (i) creating a separate UV-mapping array for a corresponding part of a mesh, (ii) using texture offsets, and/or (iii) accounting for an offset in relevant (respective) shaders.

In some implementations, there may be more than two parts of meshes. In such instances, only the texture corresponding to the lowest desired LOD level may need to be wholly loaded into GPU memory.

In some implementations, dynamic rendering component 216 may be configured to use desired LOD levels (e.g., for meshes and/or textures) pre-calculated in advance for different ranges of distances and/or angles at which the camera views an object. Due to the potential need to store only limited lists of triangles, an amount of data to store for each range may be relatively low. In some implementations, when switching between different ranges, dynamic rendering component 216 may be configured to use hysteresis to avoid too frequent of changes (e.g., when close to a range boundary). In other implementations, when performing “Intra-Mesh LOD” techniques described herein for texture(s), dynamic rendering component 216 may be configured to use a texture which is pre-split into smaller ones to avoid dealing with UV mapping. For example, dynamic rendering component 216 may be configured to select a resolution for each of textures to be loaded for a specific camera position/angle.

In some implementations, dynamic rendering component 216 may be configured to use data obtained during program test runs (such as, for example, gameplay testing) to determine which objects tend to benefit most from the “Intra-Mesh LOD” techniques described above. For example, during test runs to detect certain meshes and/or objects, triangles and/or textures may be re-loaded too often. In such implementations, the hysteresis may be increased, or the application of “Intra-Mesh LOD” techniques described herein to such objects may be avoided entirely.

In some implementations, a model/mesh may be split into several parts, with an LOD mesh produced for each part separately. Then, LODs for the mesh parts may be loaded separately (e.g., downloaded over the Internet) depending on current LOD requirements for each of the parts (i.e., based on direct calculations or pre-calculated angle/distance ranges). In such implementations, the “LOD requirements” may be calculated, for example, as a percentile (e.g., 90%) of part vertices having a desired LOD level (or farther/closer). In other implementations, a model may be split into parts based on statistics obtained during test runs. For example, the parts of a mesh that tend to be visible at the same time and/or tend to have similar desired LOD levels during gameplay may be identified, and the models may be split along a line. In some implementations, correlation coefficients for visibility/desired LOD levels may be calculated for different triangle pairs, and triangles with high correlation coefficients may be grouped together.

In some implementations, a hierarchical stream may be used to represent a mesh (or model). In some implementations, to construct the hierarchical stream, information regarding representative mesh/model may be encoded as a whole, but with low quality. For example, such information may include an initial mesh with some incremental updates. In some implementations, such information may include an “initial image” command with one or more improvement commands, as such improvement commands are described herein.

In some implementations, dynamic rendering component 216 may be configured to render a mesh based on “forward pointers” included within a compressed stream. Forward pointers may point to future positions in a stream, where an incremental improvement for some part of the stream is described. In some implementations, mesh compression component 118 may be configured to encode “forward pointers.” To point to future positions, mesh compression component 118 may be configured to leave some placeholders on a first pass of encoding, and fill placeholders later, when encoding an appropriate part of the stream.

In some implementations, an incremental improvement (i.e., including “incremental updates” to a mesh and/or “improvement commands” to texture(s)) may be encoded for a first part of a mesh (or texture). In some implementations, “forward pointers” may be encoded for sub-parts of a first part of a mesh, effectively forming a tree of incremental updates.

In various implementations, game client (or any other entity using the mesh/model) may request initial information and forward pointers first (e.g., using HTTP request), and then request a portion of a stream (i.e., a part that a game client needs better resolution for). In some implementations, “which part it needs better resolution for” may be decided, for example, based on “LOD-ness,” as described herein. In other implementations, selection may be decided by using an HTTP “range request.” HTTP may include any version of HTTP, HTTP/1.1, HTTP/2, HTTP/3, or any of now or future version of HTTP. Also, HTTP may involve requesting over LAN and/or requesting over the Internet.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., game server 110, processor(s) 112, client computer system 210, and/or processor(s) 212). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by processor(s) 112, 212, information received remotely, and/or other information that enables system 100 to function properly. For example, electronic storage 130 may store information relating to one or more three-dimensional models, one or more existing compression methods used to compress meshes, one or more existing decompression methods used to decompress meshes, information associated with different levels of detail (LODs), and/or other information related to the systems and methods described herein. In some implementations, electronic storage 130 may be configured to store, for example, a history of edge collapses and/or other actions performed during decimation, a current state (as described herein), one or more portions of various textures at different resolutions (as described herein), and/or other information related to the systems and methods described herein.

Client computer system 210 (which may also be interchangeably referred to herein as client computing device 210, client computing devices 210, or one or more client computing devices 210) may be used by users of system 100 to interface with system 100. Client computer system 210 may be configured as a server device (e.g., having one or more server blades, processors, etc.), a gaming console, a handheld gaming device, a personal computer (e.g., a desktop computer, a laptop computer, etc.), a smartphone, a tablet computing device, an Internet of Things (IoT) device, a wearable device, and/or other devices that can be programmed to interface with game server 110 and/or one or more other components of system 100.

FIG. 2 illustrates an example of a process 200 for compressing a mesh utilizing information obtained during decimation of the mesh, according to one or more aspects described herein. The operations of process 200 presented below are intended to be illustrative and, as such, should not be viewed as limiting. In some implementations, process 200 may be accomplished with one or more additional operations not described, and/or without one or more of the operations discussed. In some implementations, two or more of the operations of process 200 may occur substantially simultaneously. The described operations may be accomplished using some or all of the system components of game server 110 described in detail above. For example, process 200 may be performed by one or more processor components the same as or similar to mesh decimation component 116 and mesh compression component 118 (shown in FIG. 1 and described herein) and include one or more additional operations related to functionality described herein with respect to mesh decimation component 116 and mesh compression component 118.

In an operation 202, process 200 may include obtaining a decimated mesh and information obtained during decimation of the mesh. In some implementations, process 200 may also include decimating the mesh. In such implementations, decimation may include at least one of an edge collapse, half-edge collapse, removal of a face, or addition of a face. In various implementations, the information obtained during decimation of the mesh may comprise a record (or history) of the transforms performed on the mesh during decimation. For example, the information obtained during decimation of the mesh may comprise a record (or history) of the one or more edge collapses, half-edge collapses, removals of faces, additions of faces, and/or additional transforms performed on the mesh during decimation. In some implementations, decimating the mesh includes comparing the mesh and at least one candidate decimation based on one or more metrics. For example, in some implementations, at least one of the one or more metrics is based on a silhouette projection for a plane. In some implementations, the one or more metrics may be used to determine a decimation operation which is to be applied at each point of the decimation process. For example, the one or more metrics may be used to determine which edge to collapse next. In some implementations, decimating the mesh includes generating a bump map utilizing UV mapping. For example, the bump map may include indications of portions of a geometry of the mesh cut off during decimation.

In some implementations, obtaining the decimated mesh in operation 202 may include generating a convex mesh. In some such implementations, generating the convex mesh may comprise identifying at least one non-convex vertex within the mesh, removing any faces adjacent to the identified non-convex vertex, and closing any holes in the mesh resulting from the removal of the faces. In some implementations, closing the holes may include identifying at least one contour of a hole resulting from the removal of a face adjacent to the identified non-convex vertex, and filling the contour with face(s). In some implementations, process 202 may further include decimating the convex mesh. In such implementations, the obtained decimated mesh may comprise the decimated convex mesh.

In an operation 204, process 200 may include encoding the obtained mesh into a compressed stream. In various implementations, the obtained mesh may be encoded into a compressed stream using one or more existing mesh compression methods.

In an operation 206, process 200 may include encoding one or more incremental updates into the compressed stream using the information obtained during decimation of the mesh. In various implementations, applying the incremental updates to the decimated mesh may enable the mesh to be reconstructed from the decimated mesh. In various implementations, the one or more incremental updates include at least one of a reversal of an edge collapse or half-edge collapse, a reversal of a face removal, or a reversal of a face addition. Accordingly, in various implementations, encoding the one or more incremental updates may include encoding a reversal of an edge collapse or half-edge collapse, encoding a reversal of a face removal, and/or encoding a reversal of a face addition. In some implementations, encoding a reversal of an edge collapse or half-edge collapse may comprise encoding an edge and a difference between a predicted coordinate along the edge and a coordinate along the edge of an inserted vertex. In such implementations, the edge may be encoded as a number in a list of edges created by enumeration in the decimated mesh. In some implementations, encoding a reversal of a face removal may comprise encoding at least a first edge, a second edge, two vertices from the first edge, and one vertex from the second edge. In such implementations, the first edge, the second edge, the two vertices from the first edge and the one vertex from the second edge may create a face. In some implementations, encoding a reversal of a face addition may comprise encoding an edge followed by a flag indicating a face needing to be removed. In such implementations, the flag may indicate the face by identifying a position of the face relative to the edge. In various implementations, operation 206 may further include reordering the one or more incremental updates based on edges in the decimated mesh to which the incremental updates relate. In some implementations, a portion (or all) of a record (or history) of the transforms performed during decimation may be included in the sequence of encoded incremental updates. In such cases, incremental updates (which correspond to the reversal of the events in the decimation history) may be issued in an order inverse to the order of the events in the history of the decimation.

FIG. 3 illustrates an example of a process 300 for compressing a texture to form a continuous level of detail (LOD) of the texture, according to one or more aspects described herein. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations of process 300 may occur substantially simultaneously. The described operations may be accomplished using some or all of the system components of game server 110 described in detail above. For example, process 300 may be performed by one or more processor components the same as or similar to texture compression component 120 (shown in FIG. 1 and described herein) and include one or more additional operations related to functionality described herein with respect to texture compression component 120.

In an operation 302, process 300 may include obtaining an image representing a texture. In some implementations, the texture may comprise a square texture. In other implementations, the texture may comprise a non-square texture. In some implementations, obtaining the image representing a texture may comprise performing one or more resizing techniques on an original image representing the texture to obtain a smaller image.

In an operation 304, process 300 may include maintaining a current state of the texture. In various implementations, the current state may comprise a tree consisting of various nodes. In some implementations, each node may comprise information sufficient to rasterize the node. For example, each node may comprise one or more generalized images and boundaries between the one or more generalized images. In some implementations, the one or more generalized images may include at least one image block represented as one or more frequency-domain blocks and/or at least one noisy block comprising an image block with additional noise applied to an image described by the image block.

In an operation 306, process 300 may include compressing the image. In some implementations, the image compressed may comprise a smaller image resized from an original image as described above with respect to operation 302. In some implementations, the image may comprise a raster image, and compressing the image may comprise converting the raster image into an image block representation. In some implementations, compressing the image may include converting the image to another color space. In some implementations, compressing the image may include subsampling the image. In some implementations, compressing the image may include using two-dimensional frequency-domain transform on a block of pixels of the image to obtain a matrix of frequency coefficients. In some implementations, the two-dimensional frequency-domain transform used on the block of pixels of the image is a discrete cosine transform (DCT).

In an operation 308, process 300 may include encoding a command applied to the obtained image into a compressed stream. In various implementations, the command may include a serialization of the tree of the current state of the texture.

In an operation 310, process 300 may include encoding at least one improvement command to be applied to an image rasterized from the current state of the texture. In such implementations, the current state of the texture may similarly be maintained on the decoding side. In various implementations, the at least one improvement command comprises a scale up improvement, a coefficient improvement, and/or a new split improvement. As depicted in FIG. 3, process 300 may return to operation 304 after performing operation 310, thus allowing an iterative improvement each instance in which process 300 performs operations 304-310.

FIG. 4 illustrates an example of a process 400 for dynamically rendering a three-dimensional model based on a scene, according to one or more aspects described herein. The operations of process 400 presented below are intended to be illustrative and, as such, should not be viewed as limiting. In some implementations, process 400 may be accomplished with one or more additional operations not described, and/or without one or more of the operations discussed. In some implementations, two or more of the operations of process 400 may occur substantially simultaneously. The described operations may be accomplished using some or all of the system components of client computer system 210 described in detail above. For example, process 400 may be performed by one or more processor components the same as or similar to dynamic rendering component 216 (shown in FIG. 1 and described herein) and include one or more additional operations related to functionality described herein with respect to dynamic rendering component 216.

In an operation 402, process 400 may include determining a desired level of detail (LOD) level for a vertex of a mesh based on a current position of a camera relative to the mesh. In various implementations, determining the desired LOD level for the vertex of the mesh based on the current position of the camera relative to the mesh may comprise calculating a distance between the camera and the vertex. In some implementations, determining the desired LOD level for the vertex may comprise adjusting the desired LOD level based on the presence of one or more other objects between the camera and the mesh to be rendered. In some implementations, the desired LOD level may be adjusted based on a percentage of the mesh to be rendered that is covered by the one or more other objects between the camera and the mesh to be rendered.

In an operation 404, process 400 may include comparing the desired LOD level for the vertex to a predefined indication of a lowest-resolution LOD level for the vertex. In some implementations, the predefined indication of the lowest-resolution LOD level for the vertex may be assigned during mesh design. In some implementations, the predefined indication of the lowest-resolution LOD level for the vertex may be indicated by a position of the vertex within an encoded stream. In such implementations, the encoded stream may include at least one marker indicating that vertices in the encoded stream after the marker have a specific lowest-resolution LOD level.

In an operation 406, process 400 may include excluding the vertex from a rendering of the mesh based on a determination that the lowest-resolution LOD level for the vertex corresponds to a higher resolution than the desired LOD level. In various implementations, excluding the vertex from the rendering of the mesh may comprise using other vertices to form triangles to render the mesh.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application-such as by using any combination of digital processors, analog processors, digital circuits designed to process information, central processing units, graphics processing units, microcontrollers, microprocessors, field programmable gate arrays (FPGAs), application specific integrated circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112, 212 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112, 212 as well as data that may be manipulated by processor(s) 112, 212. The electronic storage may comprise floppy disks, hard disks, optical disks, tapes, or other storage media for storing computer-executable instructions and/or data.

Although illustrated in FIG. 1 as a single component, each of game server 110 and client computer system 210 may each include a plurality of individual components (e.g., computer devices) each programmed with at least some of the functions described herein. In this manner, some components of game server 110, client computer system 210, and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112, 212 include multiple processing units, one or more instructions may be executed remotely from the other instructions.

Although game server 110, electronic storage 130, and client computer system 210 are shown to be connected to interface 102 in FIG. 1, any communication medium may be used to facilitate interaction between any components of system 100. One or more components of system 100 may communicate with each other through hard-wired communication, wireless communication, or both. In various implementations, one or more components of system 100 may communicate with each other through a network. For example, game server 110 and/or computer system 210 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer-implemented method of compressing a mesh utilizing information obtained during decimation of the mesh, the method comprising:
obtaining a decimated mesh and information obtained during decimation of the mesh;
encoding the obtained mesh into a compressed stream; and
encoding one or more incremental updates into the compressed stream using the information obtained during decimation of the mesh, wherein applying the incremental updates to the decimated mesh enables the mesh to be reconstructed from the decimated mesh.

2. The computer-implemented method of claim 1, the method further comprising decimating the mesh, wherein decimating the mesh includes comparing the mesh and at least one candidate decimation based on one or more metrics, wherein at least one of the one or more metrics is based on a silhouette projection for a plane.

3. The computer-implemented method of claim 1, the method further comprising decimating the mesh, wherein decimating the mesh includes generating a bump map utilizing UV mapping, the bump map including indications of portions of a geometry of the mesh cut off during decimation.

4. The computer-implemented method of claim 1, wherein the mesh comprises a convex mesh, the method further comprising:
generating a convex mesh; and
decimating the convex mesh, wherein the decimated mesh comprises the decimated convex mesh.

5. The computer-implemented method of claim 4, wherein generating the convex mesh comprises:
identifying at least one non-convex vertex within the mesh;
removing any faces adjacent to the identified non-convex vertex;
identifying at least one contour of a hole resulting from the removal of a face adjacent to the identified non-convex vertex; and
filling the contour with faces.

6. The computer-implemented method of claim 1, wherein decimation includes at least one of an edge collapse, half-edge collapse, removal of a face, or addition of a face.

7. The computer-implemented method of claim 6, wherein the one or more incremental updates include at least one of a reversal of an edge collapse or half-edge collapse, a reversal of a face removal, or a reversal of a face addition.

8. The computer-implemented method of claim 7, wherein encoding a reversal of an edge collapse or half-edge collapse comprises encoding an edge and a difference between a predicted coordinate along the edge and a coordinate along the edge of an inserted vertex.

9. The computer-implemented method of claim 8, wherein the edge is encoded as a number in a current list of edges created by enumeration in the decimated mesh.

10. The computer-implemented method of claim 7, wherein encoding a reversal of a face removal comprises encoding at least a first edge, a second edge, two vertices from the first edge, and one vertex from the second edge.

11. The computer-implemented method of claim 7, wherein encoding a reversal of a face addition comprises encoding an edge followed by a flag indicating a face needing to be removed, wherein the flag indicates the face by identifying a position of the face relative to the edge.

12. The computer-implemented method of claim 1, the method further comprising reordering the one or more incremental updates based on edges in the decimated mesh to which the incremental updates relate.

13. A system for compressing a mesh utilizing information obtained during decimation of the mesh, the system comprising:
one or more processors configured by computer readable instructions to:
obtain a decimated mesh and information obtained during decimation of the mesh;
encode the obtained mesh into a compressed stream; and
encode one or more incremental updates into the compressed stream using the information obtained during decimation of the mesh, wherein applying the incremental updates to the decimated mesh enables the mesh to be reconstructed from the decimated mesh.

14. The system of claim 13, wherein the one or more processors are further configured to decimate the mesh, wherein decimating the mesh includes comparing the mesh and at least one candidate decimation based on one or more metrics, wherein at least one of the one or more metrics is based on a silhouette projection for a plane.

15. The system of claim 13, wherein the one or more processors are further configured to decimate the mesh, wherein decimating the mesh includes generating a bump map utilizing UV mapping, the bump map including indications of portions of a geometry of the mesh cut off during decimation.

16. The system of claim 13, wherein the mesh comprises a convex mesh, wherein the one or more processors are further configured to:
generate a convex mesh; and
decimate the convex mesh, wherein the decimated mesh comprises the decimated convex mesh.

17. The system of claim 16, wherein to generate the convex mesh, the one or more processors are configured to:
identify at least one non-convex vertex within the mesh;
remove any faces adjacent to the identified non-convex vertex;
identify at least one contour of a hole resulting from the removal of a face adjacent to the identified non-convex vertex; and
fill the contour with faces.

18. The system of claim 13, wherein decimation includes at least one of an edge collapse, half-edge collapse, removal of a face, or addition of a face.

19. The system of claim 18, wherein the one or more incremental updates include at least one of a reversal of an edge collapse or half-edge collapse, a reversal of a face removal, or a reversal of a face addition.

20. The system of claim 19, wherein to encode a reversal of an edge collapse or half-edge collapse, the one or more processors are configured to encode an edge and a difference between a predicted coordinate along the edge and a coordinate along the edge of an inserted vertex.

21. The system of claim 20, wherein the edge is encoded as a number in a current list of edges created by enumeration in the decimated mesh.

22. The system of claim 19, wherein to encode a reversal of a face removal, the one or more processors are configured to encode at least a first edge, a second edge, two vertices from the first edge, and one vertex from the second edge.

23. The system of claim 19, wherein to encode a reversal of a face addition, the one or more processors further configured to encode an edge followed by a flag indicating a face needing to be removed, wherein the flag indicates the face by identifying a position of the face relative to the edge.

24. The system of claim 13, wherein the one or more processors are further configured to reorder the one or more incremental updates based on edges in the decimated mesh to which the incremental updates relate.

25-62. (canceled)
